(19) United States
(12) Patent Application Publication
(10) Pub. No.: US 2016/0243449 A1
(43) Pub. Date: Aug. 25, 2016

(54) INFORMATION PROCESSING DEVICE AND GAME PROGRAM

(71) Applicant: DeNA Co., Ltd., Tokyo (JP)

(72) Inventor: Mitsuharu KUNUGI, Tokyo (JP)

(21) Appl. No.: 15/043,393

(22) Filed: Feb. 12, 2016

(30) Foreign Application Priority Data
Feb. 19, 2015 (JP) 2015-030791

(51) Int. Cl. A63F 13/847

(52) U.S. Cl. CPC A63F 13/847

(57) ABSTRACT

The information processing device pertaining to the present invention accepts participation registration for guest players who want to participate in a multiplayer game that meets a participation condition they themselves have specified, and for a host player who invites participation in a multiplayer game that he himself has specified, chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players, and controls the progress of the game so that the matched-up host player and guest player can simultaneously play the multiplayer game specified by the host player.

The present application claims the benefit of Japanese Patent Application No. JP2015-030791, filed on Feb. 19, 2015, the content of which is incorporated herein in its entirety by reference.

### BACKGROUND

1. Technical Field

The present invention relates to an information processing device and a game program (e.g., non-transitory computer readable medium having machine-executable instructions with which a computer having a storage and a hardware processor).

2. Related Art

There are known game systems that perform matching between a host player who invites participation in a multiplayer game and guest players who want to participate in a multiplayer game for which players are being recruited, and that perform control so that the host player and guest players can play the same multiplayer game at the same time (see Patent Document 1, for example).

### PRIOR ART DOCUMENT

### Patent Document

[Patent Document 1]

Japanese Patent Application 2013-34811

### Problems to be Solved by the Invention

With a game system such as this, if matching is performed by allowing the host player to choose a desired guest player, or by allowing a guest player to choose a desired host player, although this may satisfy the wishes of one of the players, it may not satisfy the wishes of the other player. If this should happen, a player will be matched up with an undesirable opponent, and this may end up making players less willing to participate in a multiplayer game.

The present invention was conceived in light of this situation, and it is an object thereof to make players more willing to participate, and to make multiplayer games more lively.

### SUMMARY

The principal invention of the present invention which intends to solve the above mentioned problems is an information processing device, comprising:

an entry processing module that accepts participation registration for guest players who want to participate in a multiplayer game that meets a participation condition they themselves have specified, from among multiple multiplayer games, and accepts participation registration for a host player who invites participation in a multiplayer game that he himself has specified from among multiple multiplayer games;

a matching processing module that chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players; and a game progress processing module that controls the progress of the game so that the matched-up host player and guest player can simultaneously play the multiplayer game specified by the host player.

Other features of the present invention will become apparent from this Specification and the accompanying Drawings.

### BRIEF DESCRIPTION OF THE DRAWINGS

FIG. 1 is a diagram illustrating an example configuration of the entire game system 1.

FIG. 2 is a block diagram illustrating the functional configuration of the server device 10.

FIG. 3 is a diagram illustrating an example data structure of character information.

FIG. 4 is a diagram illustrating an example data structure of item information.

FIG. 5 is a diagram illustrating an example data structure of game stage information.

FIG. 6 is a diagram illustrating an example data structure of player information.

FIG. 7 is a diagram illustrating an example data structure of proprietary character information.

FIG. 8 is a diagram illustrating an example data structure of proprietary item information.

FIG. 9 is a diagram illustrating an example data structure of clear information.

FIG. 10A is a table illustrating an example data structure of guest-use entry information; FIG. 10B is a table illustrating an example data structure of host-use entry information.

FIG. 11 is a diagram illustrating an example data structure of matching information.

FIG. 12 is a block diagram illustrating the functional configuration of a player terminal 20.

FIG. 13 is a flowchart illustrating an example of the operation related to matching (first half).

FIG. 14 is a flowchart illustrating an example of the operation related to matching (second half).

FIG. 15 is a diagram illustrating an example of a guest-use entry screen 50.

FIG. 16 is a diagram illustrating an example of a host-use entry screen 60.

FIG. 17 is a diagram illustrating an example of a player selection screen 70.

FIG. 18 is a diagram illustrating an example of a multiplay start screen 80.

FIG. 19 is a flowchart illustrating an operation example related to multiplay.

### DETAILED DESCRIPTION

At least the following will be apparent from this Specification and the accompanying Drawings.

Namely, an information processing device, comprising:

an entry processing module that accepts participation registration for guest players who want to participate in a multiplayer game that meets a participation condition they themselves have specified, from among multiple multiplayer games, and accepts participation registration for a host player who invites participation in a multiplayer game that he himself has specified from among multiple multiplayer games;

a matching processing module that chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players; and

a game progress processing module that controls the progress of the game so that the matched-up host player and guest player can simultaneously play the multiplayer game specified by the host player.

With this information processing device, a guest player can participate in multiplayer games that satisfy his own specified participation condition, and a host player can allow guest players that he has specified to participate in the multiplayer games that he has specified.

As a result, players will be matched up with their desired opponents, which increases the willingness of players to participate, which in turn makes the multiplayer games more lively.

In such an information processing device, the game progress processing module may be adapted to perform allocation of rewards given to each player, on the basis of the participation condition specified by the guest player, when the matched-up host player and guest player have cleared a multiplayer game.

With this information processing device, a guest player can receive rewards based on his own specified participation condition, and a host player can clear multiplayer games he has specified by simultaneously playing along with the guest players he has specified.

As a result, players will be even more willing to participate in multiplayer games.

In such an information processing device, the entry processing module may be adapted to receive the number of continuations specified by the host player and/or the guest player, and

if the matched-up host player and guest player were unable to clear a multiplayer game, the game progress processing module allows the multiplayer game that could not be cleared to continue proceeding on the basis of the number of continuations specified by the host player and/or the guest player.

With this information processing device, the host player and/or a guest player can pre-register the number of continuations upon entry, which allows him to continue simultaneous play in the same multiplayer game until it is cleared.

In such an information processing device, the entry processing module may be adapted to receive time periods in which guest players can participate in a multiplayer game, and

the matching processing module: chooses guest players who are in a time period in which they can participate in a multiplayer game and who have specified a participation condition met by the multiplayer game specified by the host player, from among the guest players who have undergone participation registration, when the host player participation registration has been accepted, and matches up said host player with the guest player specified by the host player from among these chosen guest players.

With this information processing device, a guest player can participate in a multiplayer game that is recruiting players during a time period in which he can participate, and the host player does not need to choose guest players who cannot participate at the time when the game starts. Accordingly, mutually effective matching can be performed, which allows the multiplayer game to be made more lively.

Next, a game program (e.g., non-transitory computer readable medium having machine-executable instructions with which a computer having a storage and a hardware processor), which causes a computer to execute:

entry processing that accepts participation registration for guest players who want to participate in a multiplayer game that meets a participation condition they themselves have specified, from among multiple multiplayer games, and accepts participation registration for a host player who invites participation in a multiplayer game that he himself has specified from among multiple multiplayer games;

matching processing that chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players; and game progress processing that controls the progress of the game so that the matched-up host player and guest player can simultaneously play the multiplayer game specified by the host player.

With this game program, players are more willing to participate, and a multiplayer game can be made more lively.

### Embodiments

### Configuration of Game System 1

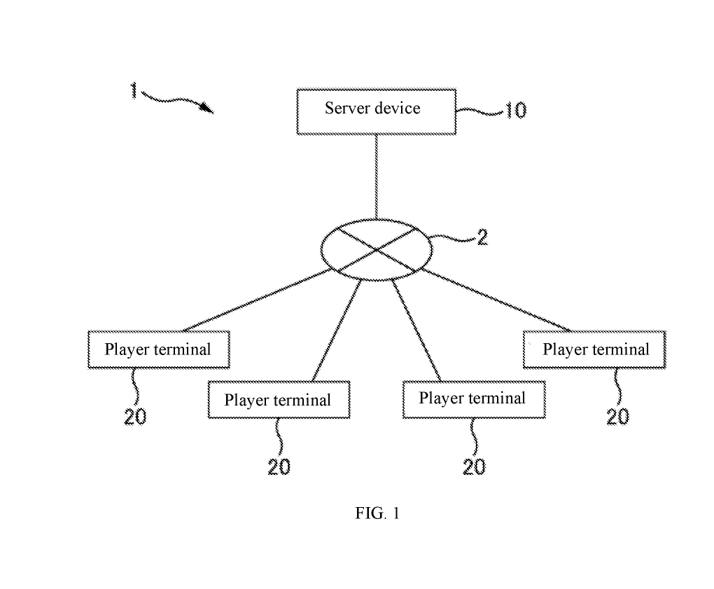

FIG. 1 is a diagram illustrating an example configuration of the entire game system 1. The game system 1 provides various game-related services to the player over a network 2 (for example, the Internet) and includes a server device 10 and multiple player terminals 20.

The game system 1 according to the present embodiment can provide the players with character battles conducted using character cards, as an example of game content objects (hereinafter referred to simply as “characters”).

In the present embodiment, the term “character battles” refers to a game in which a player character belonging to the player is directed to engage in combat with enemy characters that appear in each game stage. The player can initiate battle play in a particular game stage selected from multiple game stages. The player can acquire clearing rewards by clearing the selected game stage. Clearing rewards include enemy characters that have appeared in a game stage (hereinafter also called “appearing characters”), items, coins, experience value, etc.

In the character battle pertaining to this embodiment, a player can do solo play in which he plays as an individual as discussed above, or can engage in multiplay. In multiplay, a player enters either as a host player who invites participation in a game stage that he has specified from among multiple game stages, or as a guest player who wants to participate in a game stage for which players are being recruited. After entry, the matched-up host player and guest player can simultaneously play a character battle in a game stage specified by this host player.

### <<Configuration of Server Device 10>>

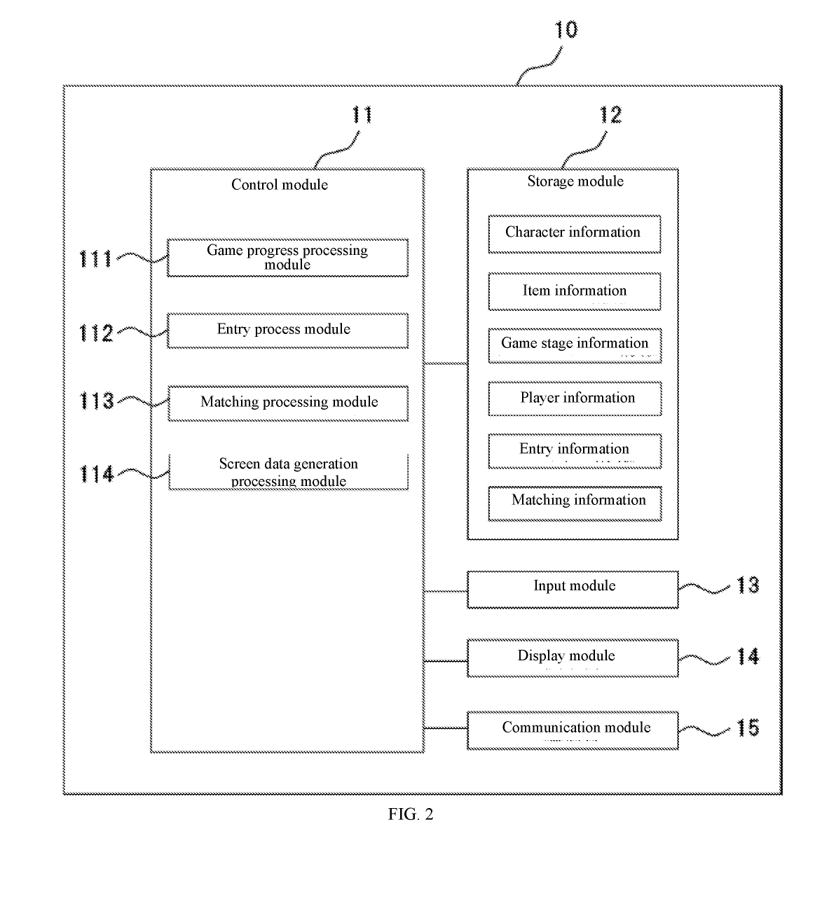

FIG. 2 is a block diagram illustrating the functional configuration of the server device 10. The server device 10 is an information processing device (for example, a workstation, a personal computer, etc.) used by a system administrator to operate and manage a variety of services. Upon receiving various commands (requests) from player terminals 20, the server device 10 transmits (responds by sending) game programs (e.g., non-transitory computer readable medium having machine-executable instructions with which a computer having a storage and a hardware processor) operational on the player terminals 20 and various types of data and web pages (game screens, etc.) created using a markup language (HTML, etc.) compliant with the specifications of the player terminals 20. The server device 10 has a control module 11, a storage module 12, an input module 13, a display module 14, and a communication module 15.

The control module 11, along with transferring data between the components, exercises overall control over the server device 10, and is implemented using a CPU (Central Processing Unit) that runs a predetermined program stored in memory. The control module 11 of the present embodiment is provided with at least a game progress processing module 111, an entry processing module 112, a matching processing module 113, and a screen data generation processing module 114.

The game progress processing module 111 possesses functionality to carry out processing to allow a battle game to proceed according to a game program (e.g., non-transitory computer readable medium having machine-executable instructions with which a computer having a storage and a hardware processor). In the case of solo play, when the operation input of an individual player is received, the game progress processing module 111 in this embodiment allows a character battle to proceed on the basis of that operation. In the case of multiplay, when operation inputs of a matched-up host player and guest player are received, the game progress processing module 111 controls the progress of the game so that a character battle can be played simultaneously on the basis of these operations.

The entry processing module 112 possesses functionality to carry out various kinds of processing related to entry into multiplay. The entry processing module 112 in this embodiment accepts participation registration for guest players who want to participate in a game stage that meets a participation condition set by themselves, out of multiple game stages in which multiplay is occurring. Also, the entry processing module 112 accepts participation registration for the host player who invites participation in the game stage he has specified out of multiple game stages in which multiplay is occurring.

The matching processing module 113 possesses functionality to carry out various kinds of processing related to matching in multiplay. When a host player participation registration has been accepted, the matching processing module 113 in this embodiment chooses those guest players who have specified a participation condition that is met by the game stage that has been specified by the host player, from among the guest players who have undergone participation registration, and matches that host player up with the guest player specified by the host player from among these chosen guest players.

The screen data generation processing module 114 possesses functionality to carry out processing used to generate screen data for displaying a game screen on a player terminal 20. The screen data generation processing module 114 of the present embodiment generates HTML data as screen data corresponding to a game screen.

The storage module 12 has a ROM (Read Only Memory), which is a read-only storage area where operating system software is stored, and a RAM (Random Access Memory), which is a rewritable storage area used as a work area for arithmetic processing by the control module 11, and is implemented as a non-volatile storage device, such as a flash memory, a hard disk, or the like. The storage module 12 of the present embodiment stores at least character information, item information, game stage information, player information, entry information, and matching information. It should be noted that the specifics of these various types of information will be described in detail further below.

The input module 13 is used by a system administrator, etc., for entering game service-related data of various types (e.g., character information, item information, game stage information, and the like), and is implemented, for example, using a keyboard, a mouse, or the like.

The display module 14, which is used for displaying operation screens used by the system administrator in response to commands from the control module 11, is implemented, for example, as an LCD (Liquid Crystal Display), or the like.

The communication module 15, which is used for communication with the player terminals 20, has receiver functionality for receiving various types of data and signals transmitted from the player terminals 20 and transmitter functionality for transmitting various types of data and signals to the player terminals 20 in response to commands from the control module 11. The communication module 15 is implemented, for example, as an NIC (Network Interface Card), or the like.

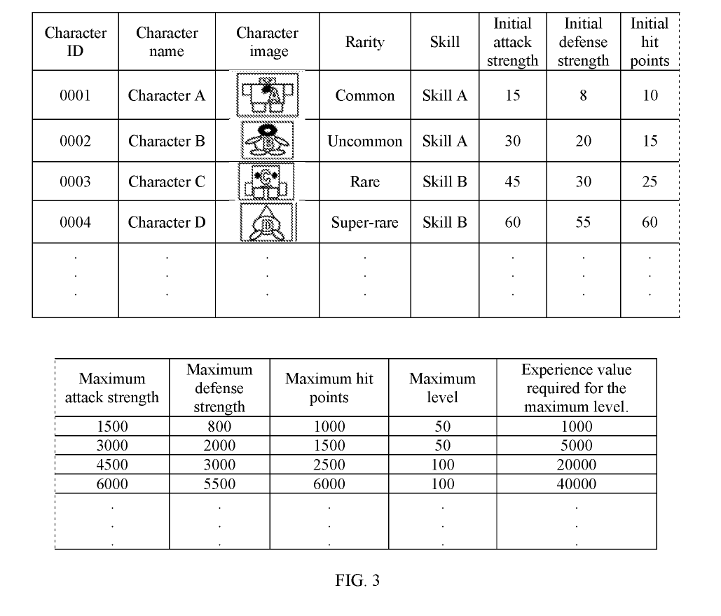

FIG. 3 is a diagram illustrating an example data structure of character information. This character information has configured therein, in correlation with a character ID, at least a character name, a character image, rarity, skill, initial attack strength, initial defense strength, initial hit points, maximum attack strength, maximum defense strength, maximum hit points, maximum level, and experience value required for the maximum level. The term “skill” refers to information indicating the special attacks and other capabilities that this character activates during a battle. The term “maximum level” refers to information indicating the maximum value set for the level of that character. The initial value for the level of all characters is set to level 1. The term “experience value required for the maximum level” refers to information indicating the experience value needed to raise the level of that character from its initial value (level 1) to the maximum level.

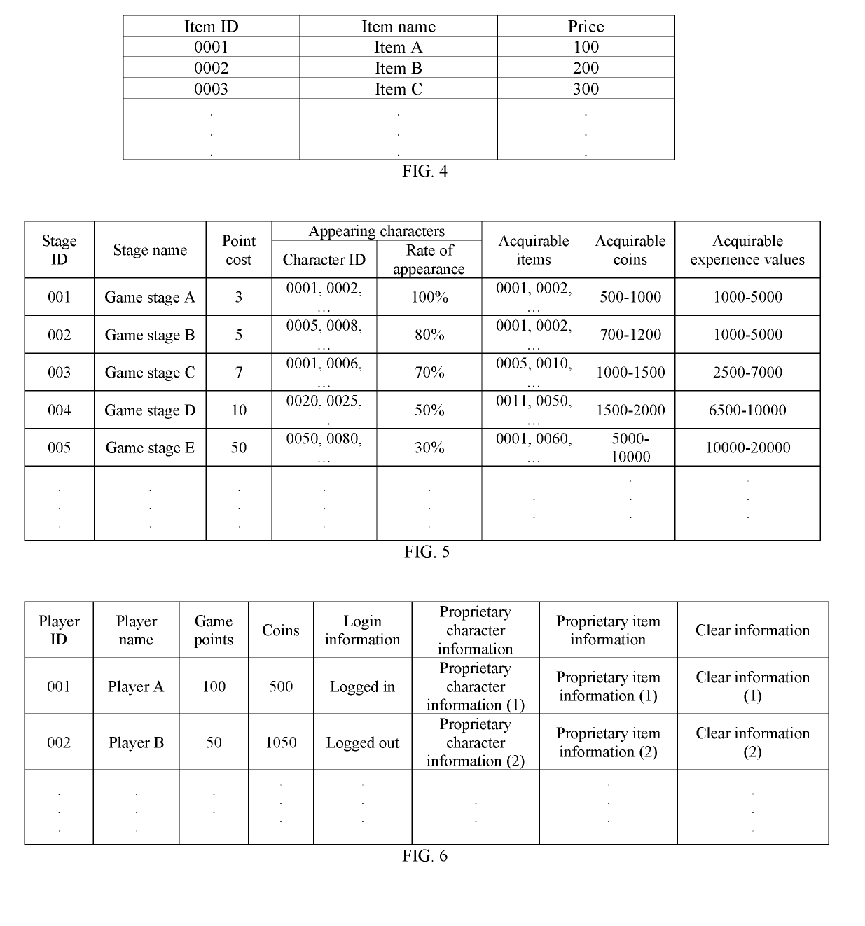

FIG. 4 is a diagram illustrating an example data structure of item information. This item information has configured therein, in correlation with an item ID, at least an item name and a price. The term “price” refers to information indicating the value of the item.

FIG. 5 is a diagram illustrating an example data structure of game stage information. This game stage information has configured therein, in correlation with a stage ID, at least a stage name, point cost, appearing characters, rate of appearance, acquirable items, acquirable coins, and acquirable experience values. The term “point cost” refers to information indicating the number of points needed to start game play at that game stage. The term “appearing characters” refers to information indicating the enemy characters that appear in the stage, or information on the rate of appearance configured therein in correlation with the character IDs of the appearing characters. The term “rate of appearance” refers to information indicating the probability of encountering the appearing characters during gameplay in that game stage. The term “acquirable items” refers to information indicating items which can be acquired at that stage. The term “acquirable coins” refers to information indicating the range of coins which can be acquired at that stage. The term “acquirable experience values” refers to information indicating the range of experience values which can be acquired at that stage.

FIG. 6 is a diagram illustrating an example data structure of player information. This player information has configured therein, in correlation with player IDs, at least a player name, game points, coins, login information, proprietary character information, proprietary item information, and clear information. The term “game points” refers to information indicating the number of points that the player has and that is consumed when the player starts the game in the game stage. The term “coins” refers to parameter information indicating the number of coins owned by a player. Coins are used up when a player purchases an item, etc. The term “login information” refers to the state of login to the game system.

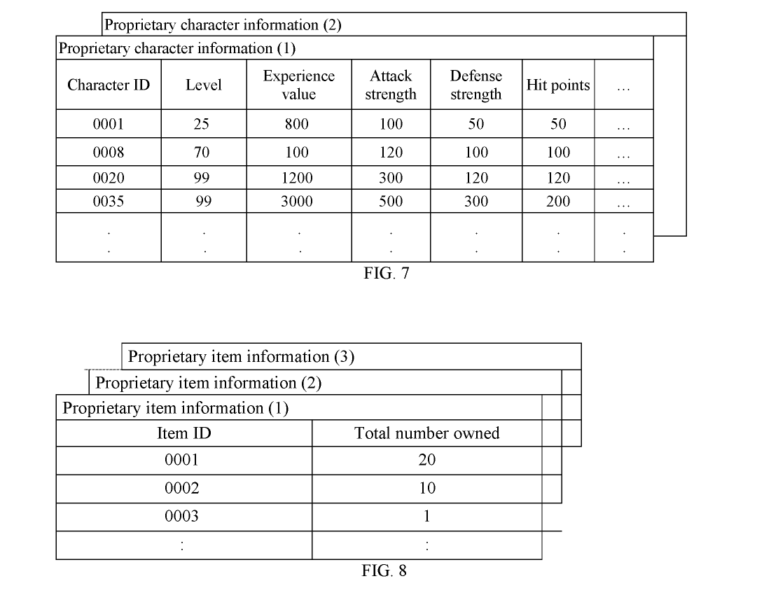

FIG. 7 is a diagram illustrating an example data structure of proprietary character information. The term “proprietary character information” refers to information relating to characters belonging to the player (hereinafter referred to as “proprietary characters”). This proprietary character information has configured therein, in correlation with the character IDs of the proprietary characters, at least a current level, experience value, attack strength, defense strength, hit points, and other various parameters. The level is a parameter indicating the strength of a character, and is set so as to rise on the basis of the experience value. The term “experience value” refers to information indicating the sum of experience values awarded when a game stage was cleared up to the present time, and is a parameter whose level can be raised in stages whenever a certain amount has been accumulated.

FIG. 8 is a diagram illustrating an example data structure of the proprietary item information. The term “proprietary item information” refers to information relating to items belonging to the player (hereinafter referred to as “proprietary items”). This proprietary item information has configured therein, in correlation with the item IDs of the proprietary items, at least the number of the items owned.

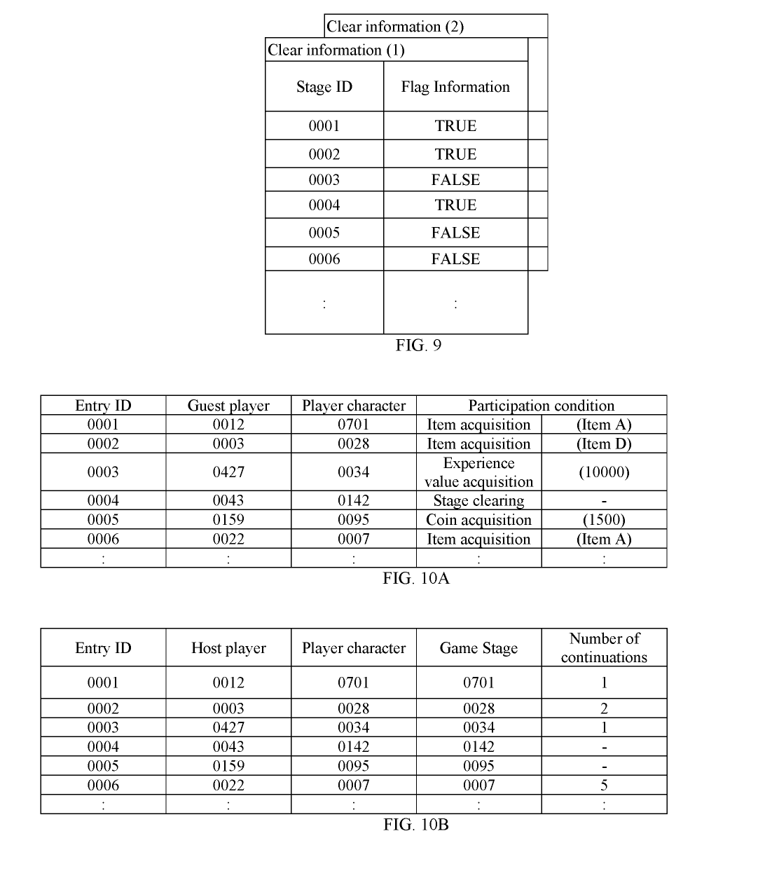

FIG. 9 is a diagram illustrating an example data structure of clear information. The term “clear information” refers to information indicating the clearing state of a player for each game stage. This clear information has configured therein, in correlation with a stage ID, at least flag information indicating whether or not the player has cleared that game stage.

FIG. 10 consists of tables of an example data structure of entry information. The term “entry information” refers to information related to a player who has entered into multiplay. The entry information in this embodiment is made up of guest-use entry information related to a guest player, and host-use entry information related to a host player.

FIG. 10A is a table illustrating an example data structure of guest-use entry information. This guest-use entry information has configured therein, in correlation with an entry ID, at least the player ID for the guest player, the character ID for the player character, and a participation condition. A player character is a character specified by a guest player from among his own proprietary characters, and is a character that performs battle with enemy characters in the multiplay game stage in which the guest player is participating. The participation condition is a participation condition specified by the guest player from among multiple participation conditions, and is a condition for narrowing down the game stage in which the guest player wants to participate, from among the game stages that are recruiting players. For instance, if the participation condition is “item acquisition (item A),” then a guest player enters on the condition of participation in a game stage in which item A can be acquired. If the condition is “experience value acquisition (10,000),” the guest player enters on the condition of participation in a game stage in which an experience value worth 10,000 points can be acquired. If the condition is “stage clearing,” the player enters on the condition of participation in a game stage which the guest player has not yet cleared. If the condition is “coin acquisition (1500),” the player enters on the condition of participation in a game stage in which 1500 coins can be acquired.

FIG. 10B is a table illustrating an example data structure of host-use entry information. This host-use entry information has configured therein, in correlation with an entry ID, at least the player ID for the host player, the character ID for the player character, the stage ID for the game stage, and the number of continuations. The term “game stage” refers to information indicating a game stage that is recruiting players, specified by the host player from among multiple game stages. The term “number of continuations” refers to information indicating the number of times play can be continued when a game stage could not be cleared in multiplay in which a guest player participated, and is the number of continuations specified by the guest player on the basis of the number of game points he has.

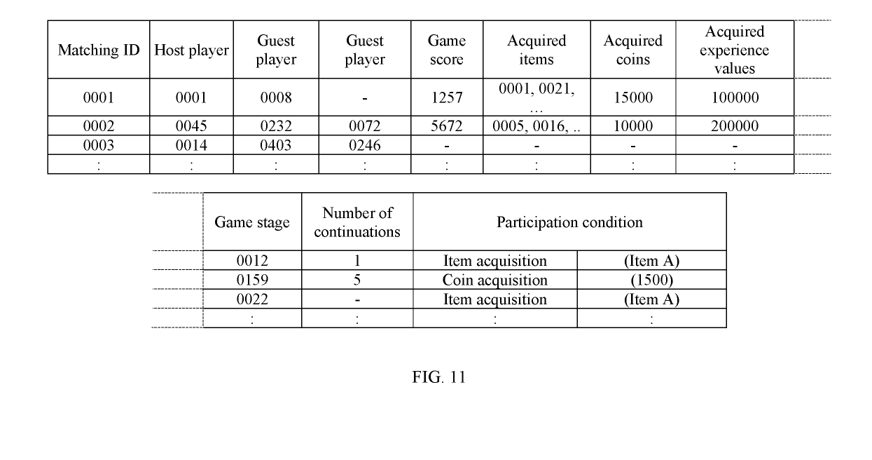

FIG. 11 is a diagram illustrating an example of the data structure of matching information. The term “matching information” refers to information related to a matched-up host player and guest player. This matching information has configured therein, in correlation with a matching ID, at least player IDs for the matched-up host player and guest player, game scores, acquired items, acquired coins, acquired experience values, game stages, the number of continuations, and participation conditions. The game score is calculated on the basis of the result of multiplay performed by the matched-up host player and guest player. The term “acquired items” refers to information indicating items acquired in multiplay by the matched-up host player and guest player. The term “acquired coins” refers to information indicating the number of coins acquired in multiplay by the matched-up host player and guest player. The term “acquired experience values” refers to information indicating the experience values acquired in multiplay by the matched-up host player and guest player. The game stages, the number of continuations, and the participation conditions are data copied from host- and guest-use entry information.

### <<Configuration of Player Terminal 20>>

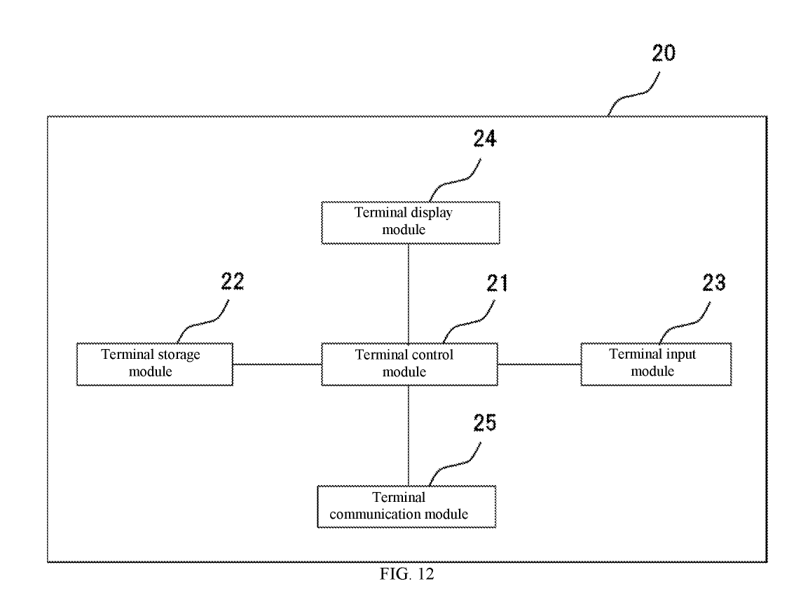

FIG. 12 is a block diagram illustrating the functional configuration of a player terminal 20. The player terminals 20 are information processing devices owned and used by the players (e.g., tablet terminals, mobile phone terminals, smartphones, and the like). Due to the web browser functionality they possess, the player terminals 20 are capable of on-screen display of web pages (game screens, and the like) transmitted from the server device 10. A player terminal 20 has a terminal control module 21 used for overall control of the player terminal 20, a terminal storage module 22 used for storing various types of data and programs, a terminal input module 23 used by the player for operation input, a terminal display module 24 used for displaying game screens and operation screens, and a terminal communication module 25 used for communicating information to and from the server device 10.

### <<Operation of Game System 1>>

Operation examples of the game system according to the present embodiment will be illustrated below. An operation example related to matching up a host player with a guest player after login, and an operation example related to multiplay (a multiplayer game) performed by multiple matched-up players will now be described in specific terms.

### <Matching>

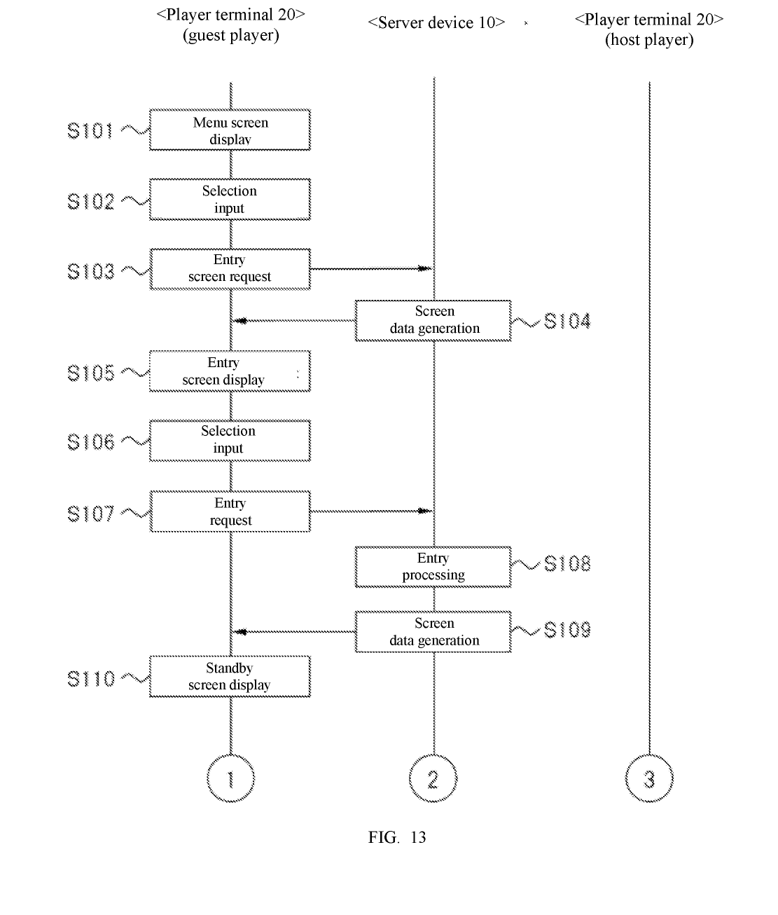

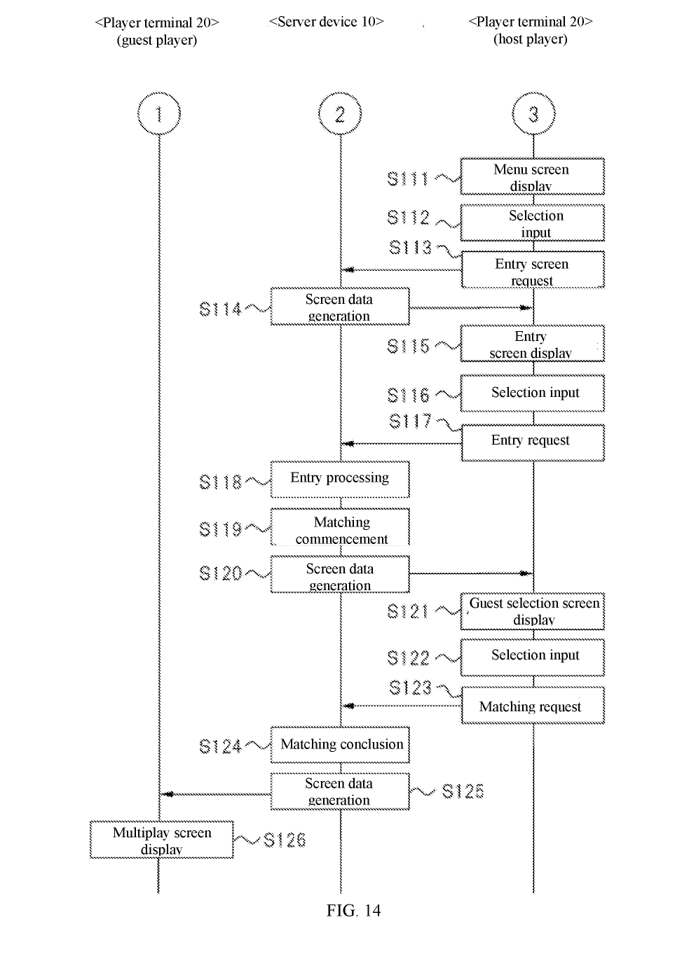

FIGS. 13 and 14 are flowcharts illustrating operation examples related to matching.

First of all, as shown in FIG. 13, the player terminal 20 used by the guest player displays menu screens on terminal display modules 24 on the basis of screen data transmitted from the server device 10 (Step S101).

Next, when a menu screen is being displayed on the terminal display module 24, and the guest player performs a selection operation to specify a control button for participating in multiplay (Step S102), the player terminal 20 of the guest player sends the server device 10 a command (entry screen request) that requests a multiplay entry screen, on the basis of this operation information (Step S103).

Next, upon receiving the entry screen request sent from the player terminal 20, the server device 10 causes the screen data generation processing module 114 to generate data for a guest-use entry screen for allowing that guest player to perform an entry operation (Step S104). The server device 10 then sends the data for the guest-use entry screen generated by the screen data generation processing module 114 over a network to the requesting player terminal 20.

Next, upon receiving the screen data sent from the server device 10, the player terminal 20 of the guest player analyzes this screen data and causes the terminal display module 24 to display a guest-use entry screen (Step S105).

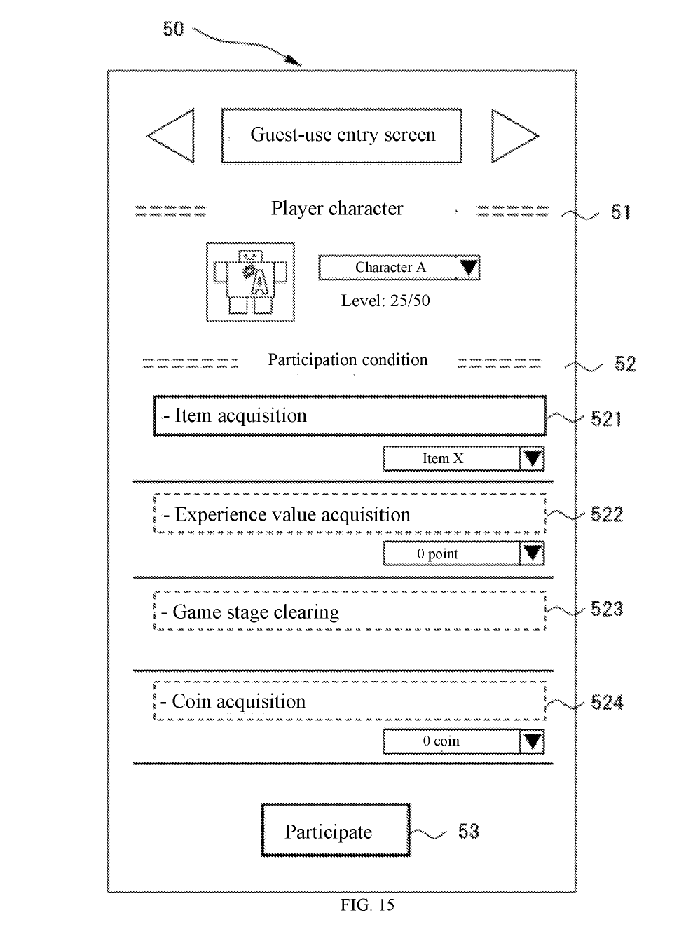

FIG. 15 is a diagram illustrating an example of a guest-use entry screen 50. This guest-use entry screen 50 includes a character selection operation area 51, a participation condition selection operation area 52, and a control button 53 for participating in multiplay. The character selection operation area 51 is an operation area for allowing a guest player to select a player character. The guest player can use the pulldown menu included in the character selection operation area 51 to specify his desired player character from among his own proprietary characters. The participation condition selection operation area 52 is an operation area for allowing a guest player to select a participation condition. The guest player can choose any of the control buttons 521 to 524 displayed as a list in the participation condition selection operation area 52 to specify his desired participation condition from among multiple participation conditions. For example, if the guest player enters under the condition of participation in a game stage in which he can acquire desired items, he selects the control button 521. Here, the guest player can specify the type of item he desires (such as “item X”) by using the pulldown menu. If the player enters under the condition of participation in a game stage in which he can acquire a desired experience value of a number of points, he selects the control button 522. Here, the player can to specify the experience value (the number of points) he desires by using the pulldown menu. Also, if the player enters under the condition of participation in a game stage that has not yet been cleared, he selects the control button 523. If the player enters under the condition of participation in a game stage in which he can acquire a desired number of coins, he selects the control button 524. Here, the player can specify the number of coins he desires by using the pulldown menu.

Next, when the guest-use entry screen 50 is being displayed on the terminal display module 24, and the guest player performs a selection operation to select the control button 53 having specified a player character and a participation condition (Step S106), the player terminal 20 of the guest player sends the server device 10 a command (entry request) that requests entry into multiplay (Step S107).

Next, upon receiving the entry request sent from the player terminal 20 of the guest player, the server device 10 executes entry processing related to that guest player (Step S108). More specifically, the entry processing module 112 accepts participation registration for a guest player who wants to participate in a game stage that meets the participation condition he himself has specified, from among multiple game stages. The entry processing module 112 then registers the player ID of that guest player, along with the specified player character and participation condition, in the guest-use entry information shown in FIG. 10A.

Next, when participation registration of a guest player is thus performed by the entry processing module 112, the server device 10 causes the screen data generation processing module 114 to generate data for a standby screen that is displayed until this guest player is matched up with a host player who has specified a game stage that meets the participation condition (Step S109). The server device 10 then sends the data for the standby screen generated by the screen data generation processing module 114, over a network to the requesting player terminal 20.

Next, upon receiving the screen data sent from the server device 10, the player terminal 20 of the guest player analyzes this screen data and causes the terminal display module 24 to display a standby screen (Step S110).

Meanwhile, as shown in FIG. 14, the player terminal 20 used by the host player causes the terminal display module 24 to display a menu screen on the basis of the screen data sent from the server device 10 (Step S111).

Next, when the menu screen is being displayed on the terminal display module 24, and the host player performs a selection operation to specify a control button for participating in multiplay (Step S112), the player terminal 20 of the host player sends the server device 10 a command (entry screen request) that requests a multiplay entry screen, on the basis of this operation information (Step S113).

Next, upon receiving the entry screen request sent from the player terminal 20, the server device 10 causes the screen data generation processing module 114 to generate data for a host-use entry screen for allowing that host player to perform an entry operation (Step S114). The server device 10 then sends the data for the host-use entry screen generated by the screen data generation processing module 114 over a network to the requesting player terminal 20.

Next, upon receiving the screen data sent from the server device 10, the player terminal 20 of the host player analyzes this screen data and causes the terminal display module 24 to display a host-use entry screen (Step S115).

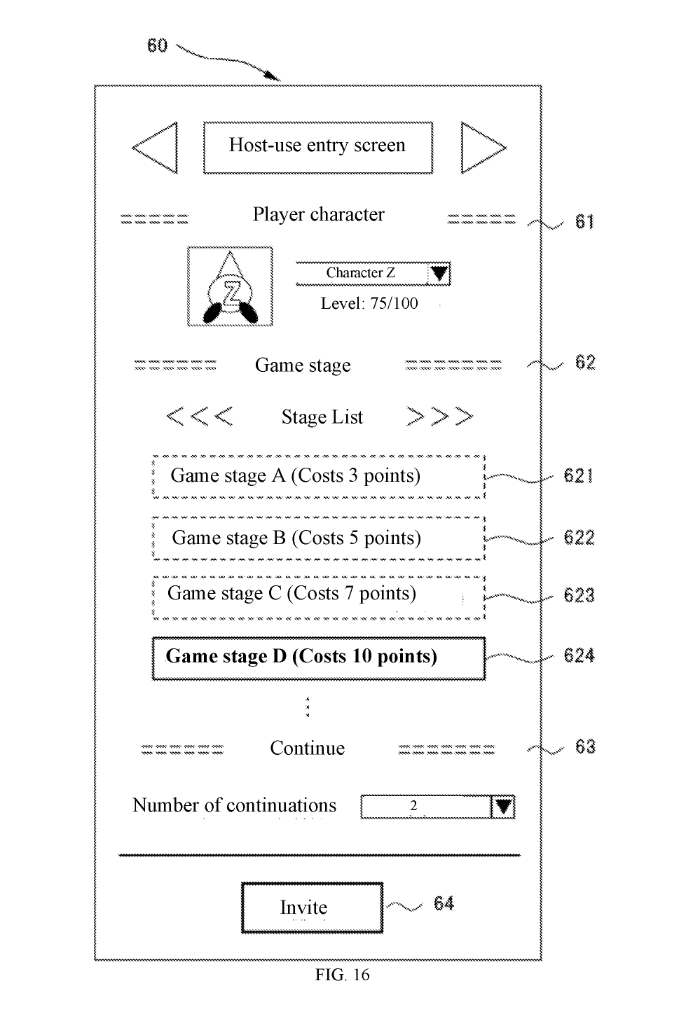

FIG. 16 is a diagram illustrating an example of a host-use entry screen 60. This host-use entry screen 60 includes a character selection operation area 61, a stage selection operation area 62, a continuation selection operation area 63, and a control button 64 for inviting participation in multiplay. The character selection operation area 61 is an operation area for allowing a host player to select a player character. The host player can use the pulldown menu included in the character selection operation area 61 to specify his desired player character from among his own proprietary characters. The stage selection operation area 62 is an operation area for allowing a host player to select a game stage. The host player can use one of the control buttons 621 to 624, etc., displayed as a list in the stage selection operation area 62 to specify his desired game stage from among multiple game stages. Each of the control buttons 621 to 624 is labeled with its stage name, as well as with the number of game points needed to perform multiplay in that game stage. The continuation selection operation area 63 is an operation area for allowing a host player to select the number of continuations. The host player can specify the number of continuations in multiplay by using the pulldown menu included in the continuation selection operation area 63.

Next, when the host-use entry screen 60 is being displayed on the terminal display module 24, and the host player performs a selection operation to select the control button 64 having specified a player character, a game stage, and the number of continuations (Step S116), the player terminal 20 of the host player sends the server device 10 a command (entry request) that requests entry into multiplay (Step S117).

Next, upon receiving the entry request sent from the player terminal 20 of the host player, the server device 10 executes entry processing related to that host player (Step S118). More specifically, the entry processing module 112 accepts participation registration for a host player who invites participation in a game stage that he himself has specified from among multiple game stages. The entry processing module 112 then subtracts the point cost (see FIG. 5) required to perform multiplay in the specified game stage from the game points owned by the host player, and updates the player information of the host player (see FIG. 6). Here, if the number of continuations has been specified by the host player, the point cost equivalent to that number of continuations is also subtracted. Next, the entry processing module 112 registers the player ID of that host player, along with the specified player character, the game stage, and the number of continuations, in the host-use entry information shown in FIG. 10B.

Next, the server device 10 commences matching when the participation registration of the host player is thus performed by the entry processing module 112 (Step S119). More specifically, the matching processing module 113 chooses guest players who specified a participation condition met by the game stage specified by that host player, from among the guest players who have undergone participation registration.

For example, if the participation condition specified by a guest player is “item acquisition,” the matching processing module 113 determines the game stage specified by the host player on the basis of the host-use entry information shown in FIG. 10B. Next, the matching processing module 113 chooses acquirable items for the game stage specified by the host player, by referring to the game stage information shown in FIG. 5. The matching processing module 113 then refers to the guest-use entry information shown in FIG. 10A to choose guest players whose participation condition is the acquisition of the chosen items.

Alternatively, if the participation condition is, for example, “experience value acquisition,” when the matching processing module 113 determines the game stage specified by the host player, it refers to the game stage information shown in FIG. 5 to determine the range of acquirable experience values for the game stage specified by the host player. The matching processing module 113 then refers to the guest-use entry information shown in FIG. 10A to choose the guest players whose participation condition is acquisition within the range of acquirable experience values thus determined.

Alternatively, if the participation condition is, for example, “game stage clearing,” when the matching processing module 113 determines the game stage specified by the host player, it chooses guest players who have not yet cleared the game stage specified by the host player on the basis of the clearing information for each guest player (see FIG. 9).

Alternatively, if the participation condition is, for example, “coin acquisition,” when the matching processing module 113 determines the game stage specified by the host player, it refers to the game stage information shown in FIG. 5 to determine the range of acquirable coins for the game stage specified by the host player. The matching processing module 113 then refers to the guest-use entry information shown in FIG. 10A to choose the guest players whose participation condition is acquisition within the range of acquirable coins thus determined.

If another host player accepts participation registration and any of the guest players among the chosen guest players was specified by the other host player within the same period of time, the specified guest player may be eliminated from among the chosen guest players.

Next, when a guest player is chosen who would be a matching candidate, the server device 10 causes the screen data generation processing module 114 to generate data for a player selection screen for allowing the host player to select a guest player (Step S120). The server device 10 then sends the data for the player selection screen generated by the screen data generation processing module 114 over a network to the requesting player terminal 20.

In the processing of Step S118 discussed above, if the host player does not have enough game points, then multiplay cannot be performed in the game stage specified by that host player, so data for the host-use entry screen 60 shown in FIG. 16, rather than the above-mentioned player selection screen, is again generated by the screen data generation processing module 114. After this, the proper game stage is again specified by the host player on the host-use entry screen 60.

Next, upon receiving the screen data sent from the server device 10, the player terminal 20 of the host player analyzes this screen data and causes the terminal display module 24 to display a player selection screen (Step S121).

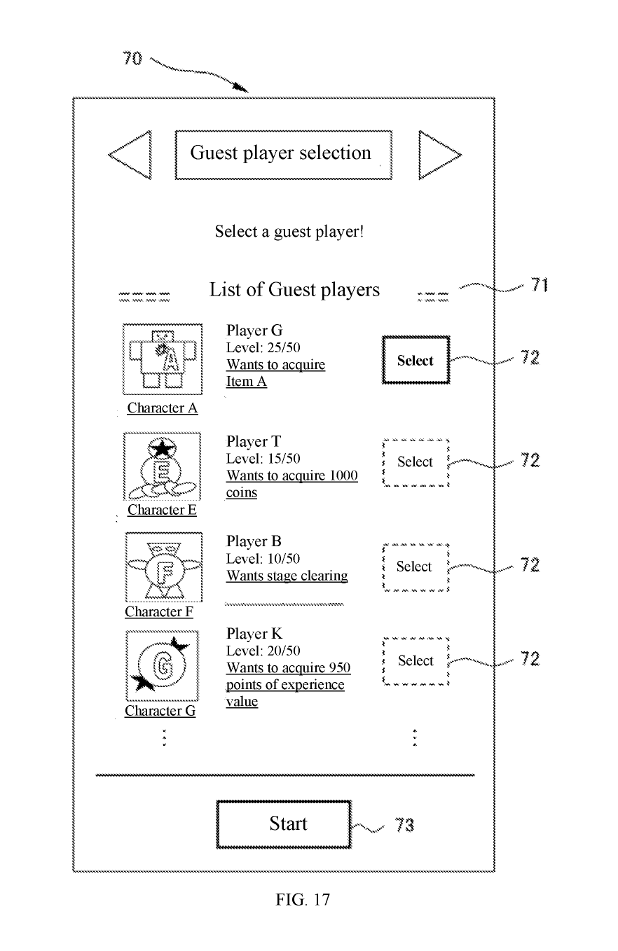

FIG. 17 is a diagram illustrating an example of a player selection screen 70. This player selection screen 70 includes a player selection operation area 71, a control button 72 for selecting a guest player, and a control button 73 for commencing multiplay. The guest players chosen by the above-mentioned processing in Step S119 are displayed as a list of selection candidates in the player selection operation area 71. The names of player characters, the level, the participation condition, and other such detailed information are also displayed, associated with the guest players that are selection candidates. For example, the host player can see the level in this detailed information, and can select guest players having player characters with higher levels than his own. Such a selection will result in guest players who are stronger than him becoming his allies, so the host player can proceed advantageously in multiplay in the game stage he has specified. Also, for example, the host player can see the participation condition from among the detailed information, and is also able to avoid selecting guest players who want the same things he does. For instance, when the host player is considering acquiring an item that a guest player also wants to acquire, if the host player ends up selecting that guest player, that item will be more likely to be taken away by the guest player during the allocation of clearing rewards (discussed below).

Next, when the player selection screen 70 is being displayed on the terminal display module 24, and the host player performs a selection operation to select the control button 73 having specified a guest player (Step S122), the player terminal 20 of the host player sends the server device 10 a command (matching request) that requests matching with that guest player (Step S123).

Next, upon receiving the matching request sent from the player terminal 20 of the host player, the server device 10 concludes the matching (Step S124). Specifically, the matching processing module 113 matches up the host player with the guest player specified by the host player. More specifically, the matching processing module 113 registers the specified guest player and the specified host player in the matching information shown in FIG. 11, and also deletes them from the guest-use entry information shown in FIG. 10A and the host-use entry information shown in FIG. 10B. As this data is deleted, part of it, such as the number of continuations and the participation condition, is registered in the matching information shown in FIG. 11.

Next, when the host player and the guest player are thus matched up, the server device 10 causes the screen data generation processing module 114 to generate data for a multiplay start screen for allowing the guest player to start the same multiplay as the host player with whom he has been matched up (Step S125). The server device 10 then sends the data for the multiplay start screen generated by the screen data generation processing module 114 over a network to the player terminal 20 of the guest player.

Next, upon receiving the screen data sent from the server device 10, the player terminal 20 of the guest player analyzes this screen data and causes the terminal display module 24 to display a multiplay start screen (Step S126).

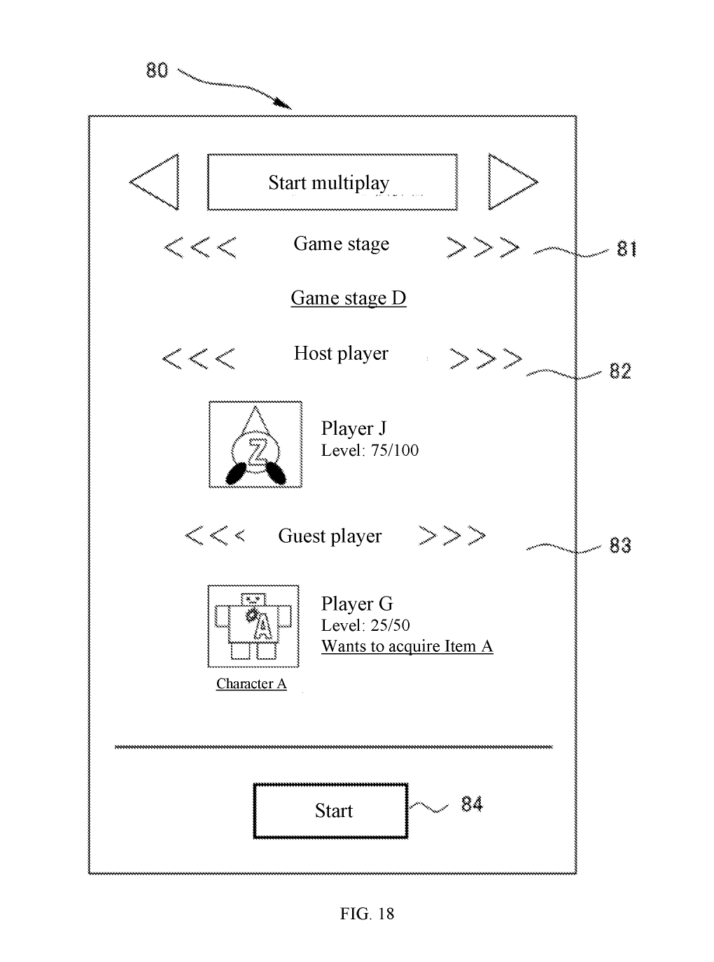

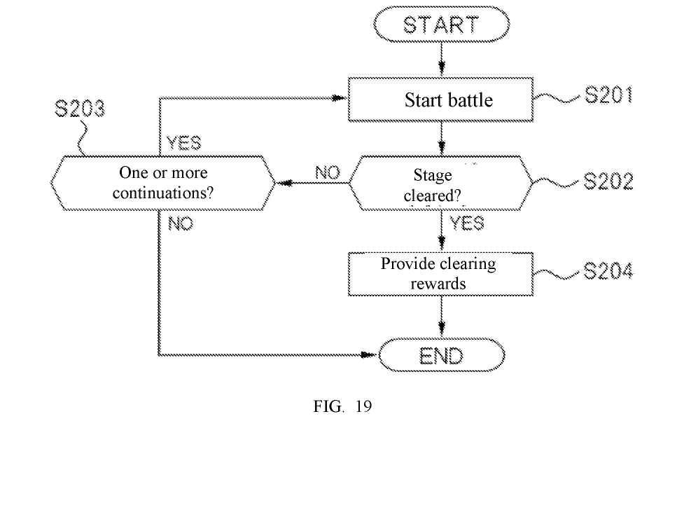

FIG. 18 is a diagram illustrating an example of a multiplay start screen 80. This multiplay start screen 80 includes a game stage display area 81, a host player display area 82, a guest player display area 83, and a control button 84 for commencing multiplay. The game stage specified by the host player is displayed in the game stage display area 81. The matched-up host player is displayed in the host player display area 82. The player character, participation condition, and so forth specified by the guest player himself are displayed as detailed information in the guest player display area 83. The guest player can start multiplay by selecting the control button 84 after first confirming the game stage in which multiplay is to be performed, and the matched-up host player.

### <Multiplay>

FIG. 19 is a flowchart illustrating an operation example related to multiplay performed by the matched-up host player and guest player.

First, the server device 10 pits the enemy characters appearing in the game stage specified by the host player against the player characters of the matched-up host player and guest player (Step S201). More specifically, when an attack on an enemy character from the player characters is commenced in response to operation input by the matched-up host player and guest player, the game progress processing module 111 calculates the damage inflicted on the enemy character on the basis of the attack strength parameters of the player characters, the defense strength parameters of the enemy character, and so forth, and reduces the hit point parameters of the enemy character according to this damage. In this way, if the hit point parameters of the enemy character can be reduced to or below a specific value first, then the game progress processing module 111 declares the host player and guest player victorious.

Next, the game progress processing module 111 determines whether or not that game stage has been cleared on the basis of whether or not the host player and the guest player were declared victorious (Step S202).

Next, if a game stage could not be cleared due to a defeat (Step S202: No), the game progress processing module 111 determines whether or not the number of continuations is at least 1 on the basis of the matching information shown in FIG. 11 (Step S203). If this determination is negative (Step S203: No), this processing is terminated. On the other hand, if the determination is positive (Step S203: Yes), the flow returns to the processing of the above-mentioned Step S201, and multiplay is recommenced.

In contrast, if a game stage was successfully cleared through victory (Step S202: Yes), the game progress processing module 111 provides clearing rewards to the host player and guest player (Step S204). In providing these clearing rewards, the game progress processing module 111 allocates the rewards provided to the players on the basis of the participation condition specified by the guest player. For instance, if the participation condition is “item acquisition,” out of the multiple items that are provided as clearing rewards, those items the guest player wanted to acquire are provided preferentially to the guest player. The clearing rewards may instead be allocated uniformly, regardless of the participation condition.

As discussed above, with the game system 1 pertaining to this embodiment, when multiplay is performed, a guest player can participate in a game stage that meets the participation condition he himself has specified, while a host player can allow guest players that he himself has specified to participate in the game stages that he himself has specified. As a result, players are matched up with the players they want to be matched with, so players will be more willing to participate, and this in turn allows a multiplayer game to be made more lively.

### Other Embodiments

The foregoing embodiment was intended to facilitate the understanding of the present invention and is not to be construed as limiting of the present invention. The present invention can be modified and improved without departing from its spirit and the present invention includes equivalents thereto. In particular, the embodiments described below are also included in the present invention.

### <Number of Continuations>

Although the present embodiment as described above has been discussed with reference to a case in which, when the host player entered multiplay, he was able to register the number of continuations he had specified, the present invention is not limited thereto. For example, when a guest player enters multiplay, he may be able to register the number of continuations that he has specified. Alternatively, both players may be able to register the number of continuations.

Also, in the above embodiment, if a stage was cleared without needing to continue, despite the fact that the number of continuations had been pre-registered by the host player or the guest player, then game points equivalent to that number of continuations may be returned to the host player or the guest player.

### <Participation Condition>

Although the present embodiment as described above has been discussed with reference to a case in which a guest player can specify “item acquisition,” “experience value acquisition,” “game stage clearing,” or “coin acquisition” as the participation condition when the guest-use entry screen 50 is being displayed, the present invention is not limited thereto. For example, a guest player may also enter on the condition of participation in a game stage that can be continued up to a number of times specified by the host player. Here, the guest player may be able to specify the desired number of continuations by using the pulldown menu in the participation condition selection operation area 52 on the guest-use entry screen 50.

Also, in the above embodiment, an example was described in which one of a plurality of participation conditions was specified by the guest player, but the configuration may instead be such that two or more participation conditions can be specified at the same time. For example, a guest player may be able to enter on the condition of participation in a game stage that can be continued up to the desired number of times, and a game stage in which the desired items can be acquired.

### <Specification of Participation Duration>

In the above embodiment, the configuration may be such that when a guest player enters multiplay, the time period in which the guest player can participate in multiplay can also be registered. In such a case, the configuration may be such that when the participation registration of the host player has been accepted, the matching processing module 113 chooses, from among the guest players who have undergone participation registration, those who are in a time period in which they can participate in multiplay, and who have specified a participation condition that is met by the game stage specified by the host player, and the host player is matched up with a guest player specified by the host player out of these chosen guest players.

### <Specification of Dropout Rate>

In the above embodiment, the configuration may be such that the dropout rate of the host player can also be registered when a guest player enters multiplay. The term “dropout” refers to logging out of the game system after having entered multiplay. The term “dropout rate” refers to the ratio of the number of times a game stage has been cleared in actual multiplay, to the number of times the player has entered multiplay so far. In such a case, the configuration may be such that the dropout rate of the host player can be specified as a participation condition for a guest player, such as in “a host player with a dropout rate of 90%.”

### <Multiplay>

Although the present embodiment as described above has been discussed with reference to a case in which multiplay was performed in a multiplayer game by two people, namely, a host player and a guest player, the present invention is not limited thereto, and can also be applied to a situation in which multiplay is performed, for example, by one host player and two or more guest players (a total of three or more players).

### <Game System>

Although the present embodiment as described above has been discussed with reference to a case in which character battles are held in game stages, the present invention is not limited thereto. In other words, the game system 1 according to the present embodiment as described above can be applied to action games, educational games, puzzle games, and so on.

### <Game Content Objects>

Although the present embodiment described above has been discussed with reference to character cards, the present invention is not limited thereto. For example, as long as it is represented by electronic game data, game content objects can be characters themselves, figures, tools or abilities used in the game, and so on.

### <Server Device>

In the above-mentioned present embodiments, the explanations are given with reference to a game system 1 equipped with a single server device 10 as an example of a service device. The invention, however, is not limited thereto and a game system 1 equipped with multiple server devices 10, as an example of server devices, may also be used. In other words, multiple server devices 10 may be connected over a network 2 and these server devices 10 may perform various types of processing in a distributed manner. It should be noted that the server device 10 is an example of a computer.

### <Information Processing Device>

In the game system 1 used in the above-mentioned present embodiment, the explanations are given with reference to a case in which various types of information processing are carried out by directing the server device 10 and the player terminals 20 to cooperate based on a game program (e.g., non-transitory computer readable medium having machine-executable instructions with which a computer having a storage and a hardware processor). The invention, however, is not limited thereto and the above-mentioned various types of information processing may be carried out based on the game program using the server device 10 alone or the player terminals 20 alone as information processing devices.

In addition, a configuration may be used in which the player terminals 20 support part of the information processing device functionality. In such a case, the server device 10 and player terminals 20 constitute an information processing device.

It should be noted that the information processing device is an example of a computer equipped with a processor and a memory.

### DESCRIPTION OF THE REFERENCE NUMERALS

1 Game system
2 Network
10 Server device
11 Control module
12 Storage module
13 Input module
14 Display module
15 Communication module
20 Player terminal
21 Terminal control module
22 Terminal storage module
23 Terminal input module
24 Terminal display module
25 Terminal communication module
50 Guest-use entry screen
51 Character selection operation area
52 Participation condition selection operation area
53 Control button
60 Host-use entry screen
61 Character selection operation area
62 Stage selection operation area
63 Continuation selection operation area
64 Control button
70 Player selection screen
71 Player selection operation area
72 Control button
73 Control button
80 Multiplay start screen
81 Game stage display area
82 Host player display area
83 Guest player display area
84 Control button
111 Game progress processing module
112 Entry processing module
113 Matching processing module
114 Screen data generation processing module
521-524 Control button
621-624 Control button

1. An information processing device, comprising:
an entry processing module that accepts participation registration for guest players who want to participate in a multiplayer game that meets a participation condition they themselves have specified, from among multiple multiplayer games, and accepts participation registration for a host player who invites participation in a multiplayer game that he himself has specified from among multiple multiplayer games;
a matching processing module that chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players; and
a game progress processing module that controls the progress of the game so that the matched-up host player and guest player can simultaneously play the multiplayer game specified by the host player.

2. The information processing device according to claim 1,
wherein the game progress processing module performs allocation of rewards given to each player, on the basis of the participation condition specified by the guest player, when the matched-up host player and guest player have cleared a multiplayer game.

3. The information processing device according to claim 1,
wherein the entry processing module receives the number of continuations specified by the host player and/or the guest player, and
if the matched-up host player and guest player were unable to clear a multiplayer game, the game progress processing module allows the multiplayer game that could not be cleared to continue proceeding on the basis of the number of continuations specified by the host player and/or the guest player.

4. The information processing device according to claim 1,
wherein the entry processing module receives time periods in which guest players can participate in a multiplayer game, and
the matching processing module:
chooses guest players who are in a time period in which they can participate in a multiplayer game and who have specified a participation condition met by the multiplayer game specified by the host player, from among the guest players who have undergone participation registration, when the host player participation registration has been accepted, and
matches up said host player with the guest player specified by the host player from among these chosen guest players.

5. A non-transitory computer readable medium having machine-executable instructions with which a computer having a storage and a hardware processor, which causes a computer to execute:
entry processing that accepts participation registration for guest players who want to participate in a multiplayer game that meets a participation condition they themselves have specified, from among multiple multiplayer games, and accepts participation registration for a host player who invites participation in a multiplayer game that he himself has specified from among multiple multiplayer games;
matching processing that chooses guest players who have specified a participation condition that is met by the multiplayer game specified by the host player, from among the guest players who have undergone participation registration, when the host player participation registration has been accepted, and matches up said host player with the guest player specified by the host player from among these chosen guest players; and
game progress processing that controls the progress of the game so that the matched-up host player and guest player can simultaneously play the multiplayer game specified by the host player.
